(19) United States
(12) Patent Application Publication
(10) Pub. No.: US 2002/0179683 A1
(43) Pub. Date: Dec. 5, 2002

(54) Hermetic optical fiber seal

(76) Inventors: Geary R. Carrier, Hampton, CT (US); Anthony Boncore, Chicopee, MA (US)

Correspondence Address: Jeffrey R. Klembczyk, JDS Uniphase Corporation, 570 West Hunt Club Road, Nepean (Ottawa), ON, K2G SW8, CA

(21) Appl. No.: 10/158,898

(22) Filed: Jun. 3, 2002

Related U.S. Application Data
(60) Provisional application No. 60/295,466, filed on Jun. 1, 2001.

(51) Int. Cl. B23K 1/00

(52) U.S. Cl. 228/133; 228/247; 228/248.1; 228/251

(57) ABSTRACT

The invention relates to a hermetic optical fiber feedthrough or connector, and a method of hermetically sealing an optical fiber at low temperature. The method involves stripping a portion of the buffer layer of an optical fiber. The stripped portion of the fiber is inserted into a ferrule having a high coefficient of thermal expansion closely matching that of a low melt temperature solder. The ferrule is heated to melt the solder, the stripped portion of the fiber is then directly soldered into the ferrule. Upon cooling the solder and ferrule cool and shrink relatively uniformly thereby forming a compressive hermetic solder joint surrounding the stripped fiber. An epoxy may be inserted into an aperture formed in the ferrule. The epoxy forms a seal around the hermetic solder joint and bonds with the stripped fiber to improve the tolerance of the hermetic seal to mechanical deformation and increases the pull strength of the seal. Advantageously, the optical properties are not altered by the process.

### CROSS-REFERENCE TO RELATED APPLICATIONS

This application claims priority from provisionally filed U.S. Serial No. 60/295,466, filed Jun. 1, 2001.

### MICROFICHE APPENDIX

Not Applicable.

### TECHNICAL FIELD

The present application relates to a method and apparatus for providing a hermetic seal of low temperature solder about an optical fiber.

### BACKGROUND OF THE INVENTION

Optical fibers are used in a wide variety of systems including telecommunications, medical technology and other optical systems. These systems include a broad range of devices which are integrated by the optical fiber network. For instance in a telecommunications network, modulators, switching devices, amplifiers and receivers are optically connected with optical fiber. These devices are generally provided as modules within hermetic packages. It is desirable to hermetically seal optical devices in a housing to prevent deterioration in performance due to the ingress of moisture or other contaminants.

Typically, the coupling ends of optical fibers, or continuous fiber feedthroughs are provided within a ferrule, which is then hermetically fixed by soldering, welding or epoxy into a coupler or a passage into the package. Optical fiber is usually formed of silica or other glass compositions. This makes bonding to the glass to form a hermetic seal more difficult.

Prior art methods of providing a hermetic seal about an optical fiber within a ferrule include providing a metal to metal bond by stripping the protective jacket or buffer layer from the optical fiber, and metal plating the exposed optical fiber. Solder is then used to bond the metalized optical fiber within a metal ferrule. An alternative method involves bonding the glass fiber to a glass ferrule using a glass solder pre-form which is heated within a glass ferrule such that the glass solder is softened to flow and form a bond between the stripped fiber and the glass ferrule. Adhesives such as UV curable adhesive or epoxies have also been used to seal optical fibers within a ferrule.

Metalizing optical fiber to provide a solder bond to the silica or other glass fiber is a manufacture intensive process with less than satisfactory results. To ensure good adhesion of the metal plating to the fiber, the fiber must be very clean. Cleaning may be accomplished using one of several alternative process steps, eg., by immersing the glass fiber in hot sulfuric acid with subsequent washing in deionized water and drying, or by chemically etching the glass fiber in hydrofluoric acid with subsequent washing and drying. The metalized fiber is brittle and subject to breakage or fiber damage. The metalization also can flake off and cause interference to the optical transmission.

Glass solder forms a very good bond with the optical fiber and the glass ferrule.

However, the melting temperature of glass solder is high (about 450 degrees C.) which requires additional manufacturing facility and time. Care must be taken not to burn the plastic buffer layer or jacket, as this can cause damage to the optical properties of the fiber.

Adhesives such as UV curable adhesive are low temperature, however, they absorb moisture from the atmosphere and change dimensions which can degrade the seal. Epoxy is also susceptible to moisture and chemicals and may break down. Moreover, epoxy has relatively poor thermal characteristics, resulting in expansion or contraction due to changes in temperature.

A further method is taught in U.S. Pat. No. 4,779,788 to Rolf Rossberg of Standard Elektrik Lorenz A. G. issued Oct. 25, 1988, to provide a hermetically sealed glass fiber bushing using metal solder without metalizing the optical fiber. This patent uses the shrinkage on cooling caused by the high coefficient of thermal expansion (CTE) of the solder to create a compressive seal about the fiber in a unbounded portion of the solder outside the ferrule and a bonded seal to a metal ferrule within the ferrule. A continuous annular of solder between the ferrule and the fiber bonded at one portion to the fiber and another portion to the ferrule, effectively provides a hermetic seal. The hermeticity of the seal depends on the compressive force of the unbound solder about the fiber. There is no external compressive force to assist in maintaining the seal. This unbound compressive seal in combination with the shrinkage of the solder away from the fiber within the ferrule offers low sealing force and low pull strength.

A hermetic metal solder connector is also taught in U.S. Pat. No. 5,815,619 to Cary Bloom, issued Sep. 29, 1998. As taught in this patent the high CTE of the solder again is responsible for shrinkage of the solder on cooling to cause a compressive seal about the fiber. The ferrule used is of stainless steel or ceramic for low thermal expansion to match the low expansion stainless steel or Kovar TM casing. This is standard in the industry. In the process taught by Bloom, the low thermal expansion ferrule is heated, the exposed portion of the fiber is placed within the through bore, and molten metal is introduced between the ferrule and the exposed region of the fiber. A bond is formed between the fiber and the ferrule during cooling of the molten metal. Aluminum is suggested as the molten metal, having a melting temperature of 900 degrees C. The ferrule is heated to 900 degrees C. in order to avoid prematurely cooling the molten metal as it is introduced. There is a significant mismatch between the CTE of the aluminum and of the ferrule. As a consequence, the aluminum cools more quickly than the ferrule. This process requires extremely high temperatures, which are difficult to handle, and as in the glass solder case risk burning the adjoining buffer layer and causing damage to the optical properties of the fiber.

A further example of providing a compressive hermetic seal is taught in U.S. Ser. No. 09/782,276 filed Feb. 14, 2001 by Wenlin Jin and assigned to the owner of the present invention, entitled “Hermetic Package with Optical Fiber Feedthrough.” In this application a two part casing is held under compressive strain by a mechanical element, while a metal solder surrounds the optical fiber in a compressive seal. The solder material has a negative coefficient of thermal expansion, and thus expands on cooling. Because metal solder does not actually bond to glass the pull strength and resistance to deformation are still rather weak, even though a good hermetic seal is formed.

There is still a need for a low temperature technique for providing a hermetic optical fiber ferrule or feedthrough assembly which is relatively simple and inexpensive to manufacture.

### SUMMARY OF THE INVENTION

The present invention has found that by providing a ferrule having a high coefficient of thermal expansion to confine a low melt temperature solder, uniform compressive stress of a metal solder can be maintained about an optical fiber providing a very good hermetic seal. The addition of an adhesive bond to the exposed glass behind the solder seal increases the pull strength of the coupling. This method can be performed at very low temperature, does not require the metalization of the fiber. Therefore the hermetic seal of the present invention does not compromise the optical properties of the optical fiber. The method of the present invention is relatively easy and inexpensive to form.

Accordingly, the present invention provides a hermetic optical fiber seal comprising:

an optical fiber having a length of buffer layer stripped away to expose a length of glass fiber;

a ferrule having a conduit therethrough for receiving the exposed length of glass fiber;

a solder bonded to and substantially filling the conduit of the ferrule and surrounding the exposed length of glass fiber within the conduit in a hermetic compressive seal;

wherein at the melting temperature of the solder, the ferrule has a coefficient of thermal expansion similar to the coefficient of thermal expansion of the solder.

An aspect of the present invention also provides a method of forming a hermetic optical fiber seal comprising the steps of:

stripping a length of buffer layer from an optical fiber to expose a length of glass fiber;

providing a ferrule having a conduit therethrough, said ferrule being formed of a material having a coefficient of thermal expansion significantly higher than that of the glass fiber;

providing a volume of solder to substantially fill the conduit, said solder composition having a coefficient of thermal expansion similar to the coefficient of thermal expansion of the ferrule material;

positioning the exposed length of glass fiber within the conduit;

heating the ferrule to a melting temperature of the solder;

surrounding the fiber with melted solder; and

cooling the ferrule and solder to form a substantially uniform compressive hermetic seal about the exposed length of glass fiber.

### BRIEF DESCRIPTION OF THE DRAWINGS

Further features and advantages of the present invention will become apparent from the following detailed description, taken in combination with the appended drawings, in which:

FIG. 1 illustrates a flow chart of a method of forming a hermetic optical fiber seal according to the present invention;

FIG. 2 illustrates a schematic diagram of an optical fiber with a center-stripped portion of the buffer layer that is prepared for a hermetic seal;

FIG. 3A illustrates a ferrule according to the present invention that is used to form a compression seal around the stripped portion of the optical fiber;

FIG. 3B illustrates an alternative ferrule according to the present invention;

FIG. 4 illustrates a hermetic feedthrough according to the present in which a pair of optical fibers are hermetically sealed.

It will be noted that throughout the appended drawings, like features are identified by like reference numerals.

### DETAILED DESCRIPTION OF THE PREFERRED EMBODIMENT

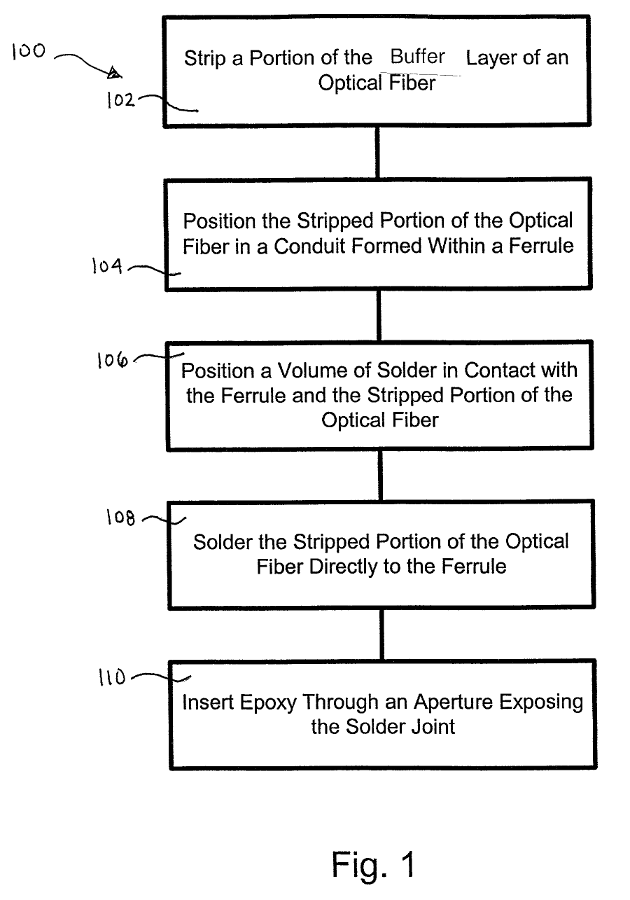

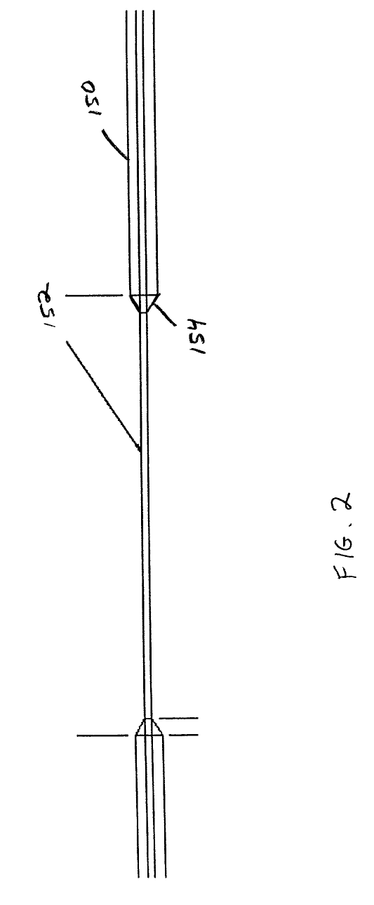

FIG. 1 illustrates a flow chart of a method 100 of forming a hermetic optical fiber seal according to the present invention. The method includes a step 102 of stripping a portion of the buffer 154 or jacket layer of an optical fiber 150 (seen in FIG. 2) to expose the glass fiber 152 in preparation for a hermetic seal. In one embodiment, the hermetic seal is used to seal a fusion splice that joins an optical fiber to an optical component. In this embodiment, the fusion splice is performed and then the exposed portion of the fiber is sealed. Alternatively, the same method is used to hermetically seal an end stripped fiber to form a connector end.

The portion of the buffer layer of the optical fiber may be stripped by using any means of chemical or mechanical oblation that does not cause significant chemical, thermal or mechanical damage to the optical fiber. There are numerous known methods of stripping buffer layers of optical fibers. For example, for a center strip, the portion of the buffer layer of the optical fiber can be bent in a U-shape and then immersed in one of numerous known chemical stripping solutions. The length of the stripped portion of the buffer layer is chosen to correspond to the length of the ferrule used to from the hermetic seal as described herein, or preferably slightly less than the length of the ferrule.

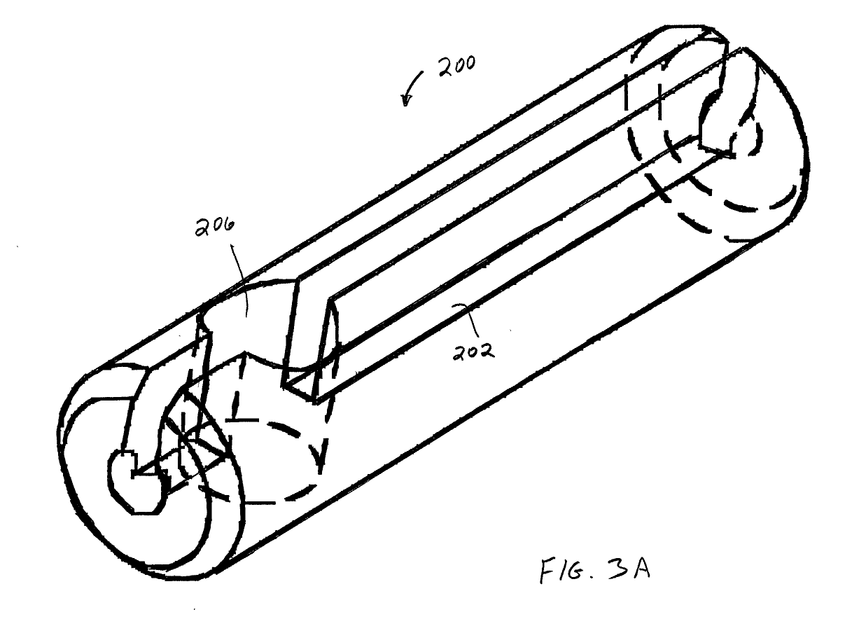

The method also includes a step 104 of positioning the stripped portion of the optical fiber 152 in a conduit or bore 202 formed within a ferrule 200 (shown in FIGS. 3A and 3B). The ferrule can have numerous shapes as described herein. The optical fiber is typically positioned approximately in the center of the ferrule. The small clearance between a common prior art ferrule inner bore and the fiber makes it difficult to insert the fiber without damage. It is important that the stripped fiber not touch the edges of the ferrule during assembly, as scratches or nicks will damage the fiber causing optical scattering, or fiber breakage. The slot 202 or 204 improves the manufacturability of the hermetic optical fiber seal and reduces the risk of damage to the stripped fiber. The fiber is held in position within the ferrule in a jig in order to prevent the fiber from floating on the melted solder.

The method also includes a step 106 of positioning a volume of solder in contact with the ferrule and the stripped portion of the optical fiber. In one embodiment, a solder perform or solder pellet having a predetermined volume of solder is positioned in contact with the ferrule. As is known in the art, the solder perform is coated with flux which prepares the metal surface of the inner bore or slot of the ferrule for bonding with the solder. In one embodiment, the ferrule includes an aperture 206 for receiving the solder. The aperture 206 improves the manufacturability of the hermetic optical fiber seal.

The ferrule is formed of a material having a high CTE which closely matches the CTE of the low melt temperature solder. Both the ferrule and the solder have a coefficient of thermal expansion greater than about 15 μm/m° C. In addition, the material should have a relatively low specific heat in order to efficiently transfer heat for even cooling throughout the assembly. This is important to maintaining the optical properties of the optical fiber. A preferred material is a copper alloy which has good machining properties for simplified manufacture.

In addition, the method includes a step 108 of sealing the stripped portion of the optical fiber within the ferrule with solder. The temperature of the ferrule is elevated to a temperature where the solder flows. The molten solder directly contacts the stripped optical fiber. The application of a small tension to the fiber within the ferrule is advantageously employed to counter wetting forces or floating the fiber which tend to de-center the fiber.

A preferred solder is tin lead eutectic solder such as 63Sn37Pb, which has a CTE of 24.7 μm/m° C., which has a melt temperature of 183 degrees C. This very low temperature solder provides significant advantages in manufacturing procedure and in maintaining optical quality of the optical fiber. The solder is relatively soft, to provide an even compressive seal about the optical fiber. Other alternatives include tin silver solders and other tin lead alloys.

As the solder seal is formed, the solder and ferrule expand on heating and then contract during cooling to form a compression seal around the stripped portion of the optical fiber. The relatively soft solder is compressed like an o-ring by the ferrule about the fiber. Because the CTE of the ferrule and the solder are closely matched and the ferrule has a low specific heat, the heat transfer through the assembly is quite uniform, with the result that the compression seal formed around the fiber does not significantly distort the physical dimensions or create significant levels of stress within the optical fiber, and therefore, only minimally changes the optical properties of the fiber. For example, the hermetic seal does not compress the optical fiber enough to significantly change the polarization characteristics of the fiber.

In addition, in one embodiment, the method includes the step 110 of inserting epoxy or similar material into the aperture adjacent to the solder. The epoxy flows over the solder joint and bonds with the exposed optical fiber. The adhesive also recoats and seals the exposed fiber to the buffer layer. Numerous types of epoxy or adhesive can be used. For example UV curable adhesive can be used. This is relatively easy to apply and improves the manufacturability of the hermetic optical fiber seal. Using epoxy is advantageous because it bonds to the exposed fiber and thereby increases the pull strength of the hermetic optical fiber seal. It also reduces stress in the hermetic seal during mechanical deformation. The hermetic fiber seal in accordance with the present invention has a relatively high tolerance to mechanical deformation, particularly in comparison to prior art hermetic fiber seals that metalize the stripped portion of the optical fiber prior to soldering.

The method of hermetically sealing an optical fiber of the present invention can be used with any type of optical fiber including single mode, multi-mode and polarization preserving optical fiber. The method of hermetically sealing an optical fiber of the present invention has numerous advantages over prior art methods. The primary advantage is the low temperature at which the seal is formed which prevents damage to the optical fiber, and greatly simplifies the manufacturing process. The compressive seal is also improved over other metal solder techniques as the CTE matched ferrule serves to impose compressive pressure bounding the solder to maintain the compressive seal. A further advantage is that the method does not require metalizing the stripped portion of the optical fiber prior to soldering the optical fiber to the ferrule. Metalizing optical fibers is problematic. For example, metalized optical fibers are mechanically brittle and, therefore are easily broken. Also, the hermetic seal of the present invention is relatively easy and inexpensive to produce.

FIG. 2 illustrates a schematic diagram of an optical fiber 150 with a stripped portion 152 of the buffer layer 154 that is prepared for a hermetic seal. The portion 152 of the buffer layer 154 of the optical fiber 150 may be stripped using any means of chemical or mechanical oblation that does not cause significant chemical, thermal, or mechanical damage to the optical fiber 150. The length of the stripped portion 152 of the buffer layer 154 is usually less than the length of the ferrule used to form the hermetic seal.

FIG. 3A illustrates a ferrule 200 according to the present invention that is used to form a compression seal around the stripped portion 152 (FIG. 2) of the optical fiber 150. The material forming the ferrule 200 is chosen so that the thermal expansion of the material closely matches that of the solder. In one preferred embodiment, the ferrule 200 is formed of copper C145, which has a CTE of approximately 17.1 μm/m° C. This is combined with a preferred solder of tin lead, 63Sn37Pb, which has a CTE of about 24.7 μm/m° C. Copper alloy is desirable because it has a relatively low specific heat. Copper alloy also has a density and hardness that is similar to some desirable solder materials. In addition, copper alloy is easy to machine, and therefore, improves the manufacturability and reduces the cost to form the hermetic seal.

The length of the ferrule is chosen so that thermal expansion of the ferrule material does not change the optical properties of the fiber. For example, the stripped portion 152 of the optical fiber 150 may be 7 mm long and the length of the ferrule 200 may be 10 mm long.

The ferrule 200 includes a conduit 202 for passing the optical fiber 150 and surrounding the stripped portion 152 of the optical fiber 150 and the solder. In one embodiment, the conduit 202 comprises at least one slot to position the stripped portion 152 of the optical fiber 150. In other embodiments, the ferrule 200 does not include the slot 202 and the stripped portion 152 of the optical fiber 152 is fed through the center bore of the ferrule 200.

In one embodiment, the ferrule 200 includes an aperture 206 for receiving a solder perform, such as a solder pellet. The solder pellet has a predetermined volume of solder. Upon heating of the ferrule, the solder melts to fill the slot 202 to form a hermetic seal between the stripped portion 152 of the optical fiber 150 and the ferrule 200 as described herein.

The aperture 206 facilitates applying the solder to the stripped portion 152 of the optical fiber 150. However, the aperture 206 is not necessary to form the hermetic seal of the present invention. In other embodiments, solder is wicked through the center bore of the ferrule 200. The aperture 206 can also be used to insert an epoxy after the hermetic solder joint is formed as describe herein. The epoxy forms a strain relief region that will increase the pull strength of the hermetic seal.

FIG. 3B illustrates an alternative ferrule 200′ where the slot 204 is only partially open providing a complete surrounding body for a portion of the length.

In an example hermetic single fiber feedthrough of copper C145 and tin lead solder, 63Sn37Pb, in accordance with the present invention, the seal quality was tested to be better than 10⁻⁸ atm. cc/sec, which is at least as good as prior art methods. The pull strength average was 2.5 Kg, which is significantly higher than prior art methods. And the environmental stability tested 3000 hours at 85 degrees C. Also, the polarization extinction ratio of polarization maintaining fibers, in the same ferrule/solder combination, measured an average of 4 dB or more better than metallized fibers common to the industry.

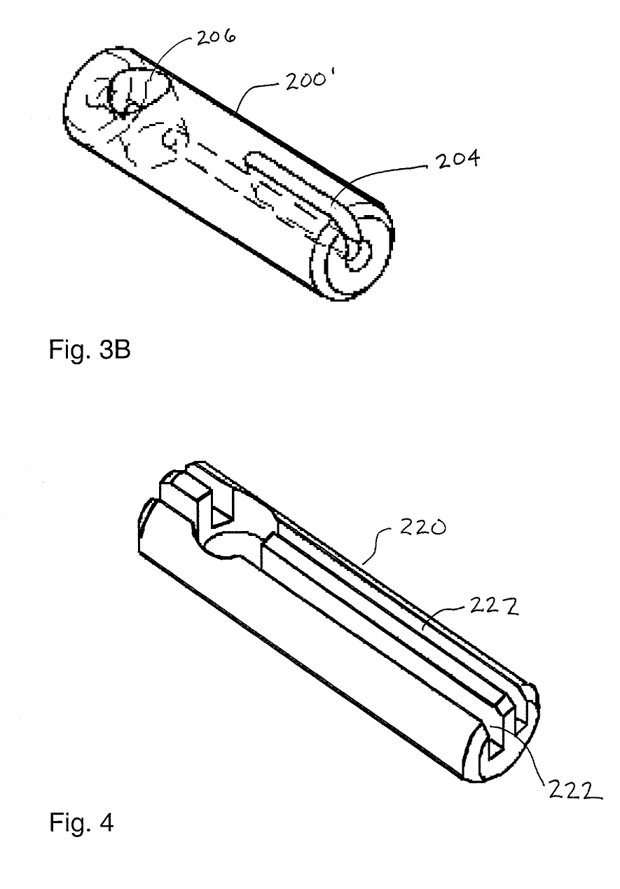

In one embodiment shown in FIG. 4, the ferrule 220 is designed to form a compressive seal around the stripped portion of a pair of aligned optical fibers 150. Such a ferrule is also useful for large optical fiber communication systems where optical components are coupled to multiple optical fibers or where multiple optical components in close proximity are coupled to multiple optical fibers. The ferrule 220 has a pair of parallel slots 222 for individually sealing the fibers within the solder.

The embodiments of the invention described above are intended to be exemplary only. The scope of the invention is therefore intended to be limited solely by the scope of the appended claims.

What is claimed is:

1. A hermetic optical fiber seal comprising:
an optical fiber having a length of buffer layer stripped away to expose a length of glass fiber;
a ferrule having a conduit therethrough for receiving the exposed length of glass fiber;
a solder bonded to and substantially filling the conduit of the ferrule and surrounding the exposed length of glass fiber within the conduit in a hermetic compressive seal;
wherein at the melting temperature of the solder, the ferrule has a coefficient of thermal expansion similar to the coefficient of thermal expansion of the solder.

2. A hermetic optical fiber seal as defined in claim 1, wherein the ferrule and the solder have a coefficient of thermal expansion greater than 15 μm/m° C.

3. A hermetic optical fiber seal as defined in claim 2, wherein the solder has a melting temperature less than 300 degrees centigrade.

4. A hermetic optical fiber seal as defined in claim 3, wherein the solder has a melting temperature of less than 200 degrees centigrade.

5. A hermetic optical fiber seal as defined in claim 3, further including an adhesive bonding at least a portion of the exposed length of glass fiber to the ferrule.

6. A hermetic optical fiber seal as defined in claim 5 wherein the adhesive is bonded within the conduit of the ferrule.

7. A hermetic optical fiber seal as defined in claim 5, wherein the solder is selected from tin lead alloys including tin lead and tin silver.

8. A hermetic optical fiber seal as defined in claim 7, wherein the ferrule is formed of a copper alloy.

9. A hermetic optical fiber seal as defined in claim 5, wherein the ferrule conduit comprises a slot.

10. A hermetic optical fiber seal as defined in claim 9, wherein the slot further includes an aperture for containing a solid solder perform during fabrication.

11. A hermetic optical fiber seal as defined in claim 9, wherein the hermetic optical fiber seal comprises a feedthrough and the length of exposed glass fiber is center stripped.

12. A hermetic optical fiber seal as defined in claim 9, wherein the hermetic optical fiber seal comprises a connector and the length of exposed glass fiber is end stripped.

13. A method of forming a hermetic optical fiber seal comprising the steps of:
stripping a length of buffer layer from an optical fiber to expose a length of glass fiber;
providing a ferrule having a conduit therethrough, said ferrule being formed of a material having a coefficient of thermal expansion significantly higher than that of the glass fiber;
providing a volume of solder to substantially fill the conduit, said solder composition having a coefficient of thermal expansion similar to the coefficient of thermal expansion of the ferrule material;
positioning the exposed length of glass fiber within the conduit;
heating the ferrule to a melting temperature of the solder;
surrounding the fiber with melted solder; and
cooling the ferrule and solder to form a substantially uniform compressive hermetic seal about the exposed length of glass fiber.

14. A method of forming a hermetic optical fiber seal as defined in claim 13, wherein the material of the ferrule has a coefficient of thermal expansion of at least 15 μm/m° C.

15. A method of forming a hermetic optical fiber seal as defined in claim 14, wherein the melting temperature of the solder is less than 300 degrees centigrade.

16. A method of forming a hermetic optical fiber seal as defined in claim 14 wherein the melting temperature of the solder is less than 200 degrees centigrade.

17. A method of forming a hermetic optical fiber seal as defined in claim 15, further including the step of applying an adhesive for bonding a portion of the length of exposed glass fiber to the ferrule.

18. A ferrule for forming a compressive hermetic seal about a glass optical fiber comprising;
a body having two ends and a conduit therethrough substantially surrounded by the body, said body formed of a material having a coefficient of thermal expansion of at least 15 μm/m° C.

19. A ferrule as defined in claim 18, wherein the conduit comprises a slot.

20. A ferrule as defined in claim 19 wherein the ferrule is formed of a copper alloy.
